(19) United States
(12) Patent Application Publication
(10) Pub. No.: US 2003/0111533 A1
(43) Pub. Date: Jun. 19, 2003

(54) RGB led based white light control system with quasi-uniform color metric

(75) Inventor: Chin Chang, Yorktown Heights, NY (US)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/024,738

(22) Filed: Dec. 19, 2001

(51) Int. Cl. G06K 7/10; G06K 7/14

(52) U.S. Cl. 235/454

(57) ABSTRACT

The present invention is directed to a color control system for generating a desired white light by a plurality of Red, Green and Blue light emitting diodes (LEDs) comprised of a sensor responsive to a white light generated by the plurality of LEDs to measure the color coordinates of the white light, where the color coordinates are defined in a first color space. A transformation module is provided coupled to the sensor to transform the coordinates of the generated white light to a second color space. A reference module configured to provide reference color coordinates corresponding to the desired white light, where the reference color coordinates are expressed in the second color space. An adder is provided coupled to the transformation module and the reference module configured to generate an error color coordinate corresponding to a difference between the desired white light color coordinates and the generated white light color coordinates. A driver module is provided coupled to the adder and configured to generate a drive signal for driving the LEDs.

### RELATED APPLICATIONS

This application is related to a copending patent application entitled AN ADAPATIVE CONTROL SYSTEM AND METHOD WITH SPATIAL UNIFORM COLOR METRIC FOR RGB LED BASED WHITE LIGHT ILLUMINATION, attorney docket number US/US/010,656, filed concurrently with the present application and assigned to the same assignee.

### FIELD OF THE INVENTION

This invention relates to a color mixing system and method and more specifically to an RGB, light emitting diode controller for providing desired colors.

### BACKGROUND OF THE INVENTION

Conventional color control systems employ a feedback control arrangement to maintain a desired color emitted by for example an RGB, LED light source. However, it is known that visual sensitivity to small color differences is one of the considerations when determining the precision of a color control system.

Traditionally, in order to control and maintain a desired light color and intensity, a color space diagram is employed and various primary color light sources, such as Red, Green and Blue are controlled in accordance with the values represented by the color space diagram.

An exemplary color space is the RGB space, which is represented by a three-dimensional space whose components are the red, green, and blue intensities, along with their spectrum that make up a given color. For example, scanners read the amounts of red, green, and blue light that are reflected from an image and then convert those amounts into digital values. Displays receive the digital values and convert them into red, green, and blue light seen on screen. RGB-based color spaces are the most commonly used color spaces in computer graphics, primarily because they are supported by many color displays and scanners. However, a shortcoming with using an RGB color space is that it is device dependent and additive.

Some color spaces can express color in a device-independent way. Whereas RGB colors vary with display and scanner characteristics, device-independent colors are meant to be true representations of colors as perceived by the human eye. These color representations, called device-independent color spaces, result from work carried out in 1931 by the Commission Internationale d'Eclairage (CIE) and for that reason they are also called CIE-based color spaces.

The CIE created a set of color spaces that specify color in terms of human perception. It then developed algorithms to derive three imaginary primary constituents of color—X, Y, and Z—that can be combined at different levels to produce all the color the human eye can perceive. The resulting color model, CIE, and other CIE color models form the basis for all color management systems. Although the RGB and CMYK values differ from device to device, human perception of color remains consistent across devices. Colors can be specified in the CIE-based color spaces in a way that is independent of the characteristics of any particular display or reproduction device. The goal of this standard is for a given CIE-based color specification to produce consistent results on different devices, up to the limitations of each device.

There are several CIE-based color spaces, such as xyL, uvL, u*v*L, a*b*l, etc., but all are derived from the fundamental XYZ space. The XYZ space allows colors to be expressed as a mixture of three tristimulus values X, Y, and Z. The term tristimulus comes from the fact that color perception results from the retina of the eye responding to three types of stimuli. After experimentation, the CIE set up a hypothetical set of primaries, XYZ, that correspond to the way the eye's retina behaves.

The CIE defined the primaries so that all visible light maps into a positive mixture of X, Y, and Z, and so that Y correlates approximately to the apparent lightness of a color. Generally, the mixtures of X, Y, and Z components used to describe a color are expressed as percentages ranging from 0 percent up to, in some cases, just over 100 percent. Other device-independent color spaces based on XYZ space are used primarily to relate some particular aspect of color or some perceptual color difference to XYZ values.

FIG. 1 is a plot of a chromaticity diagram as defined by CIE (Commission Internationale de l'Eclairage). Basically, the CIE chromaticity diagram of FIG. 1 illustrates information relating to a standard set of reference color stimuli, and a standard set of tristimulus values for them. Typically, the reference color stimuli are radiations of wavelength 700 nm for the red stimulus (R), 546.1 nm for the green stimulus (G) and 435.8 nm for the blue stimulus (B). Different color points along curve 60 can be combined to generate a white light depicted at point 62. The chromaticity diagram shows only the proportions of tristimulus values; hence bright and dim colors having the same proportions belong to the same point.

As mentioned before, one drawback of the XYZ space as employed for controlling an RGB light source is that in a system that is configured to control a desired color point, for example, X_{W}, Y_{W}, Z_{W}, a deviation from this desired color point may have a different visual impact, depending on the direction of the deviation. That is the perceptual color difference for the same amount of error in the color point location, would be different depending on where the color point with error is located, on the chromaticity diagram, in relation to the desired color point location.

Therefore, even if a system is employed with a very small error control scheme, the perceptual color difference may be still large for certain errors and excessively small for other color point errors. As such, the feedback system either over compensates or under compensates color point errors.

Thus, there is a need for an RGB LED controller system that employs a feedback control arrangement that substantially corrects all color point errors without visual perception of change in color.

### BRIEF SUMMARY OF THE INVENTION

In accordance with one embodiment of the invention, a control system for generating a desired white light by a plurality of Red, Green and Blue light emitting diodes (LEDs) comprises a sensor responsive to a white light generated by the LEDs to measure the color coordinates of the white light, wherein the color coordinates are defined in an X, Y, Z color space. A transformation module is coupled to the sensor to transform the coordinates of the generated white light to a second color space, such as an L,u,v color space. A reference module is configured to provide reference color coordinates corresponding to the desired white light, wherein the reference color coordinates are expressed in the second color space. An error module is coupled to the transformation module and the reference module and is configured to generate an error color coordinate corresponding to a difference between the desired white light color coordinates and the generated white light color coordinates. A driver module is coupled to the error module and is configured to generate a drive signal for driving the LEDs.

### BRIEF DESCRIPTION OF THE DRAWINGS

FIG. 1 illustrates a color space diagram in accordance with one embodiment of the invention.

FIG. 2 is block diagram of a control system in accordance with one embodiment of the invention.

FIGS. 3(a)-3(c) illustrate various tristimulus filters employed in accordance with another embodiment of the invention.

FIGS. 4(a)-4(b) illustrate plots employed in connection with tristimulus filters illustrated in FIG. 3.

FIG. 5 is a block diagram of a control system in accordance with another embodiment of the invention.

FIG. 6 illustrates a plot of a color space depicting error regions in accordance with one embodiment of the invention.

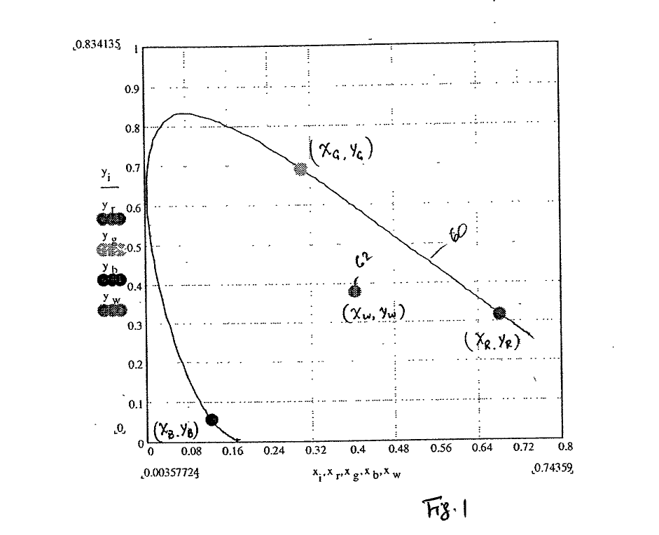

### DETAILED DESCRIPTION OF THE DRAWINGS

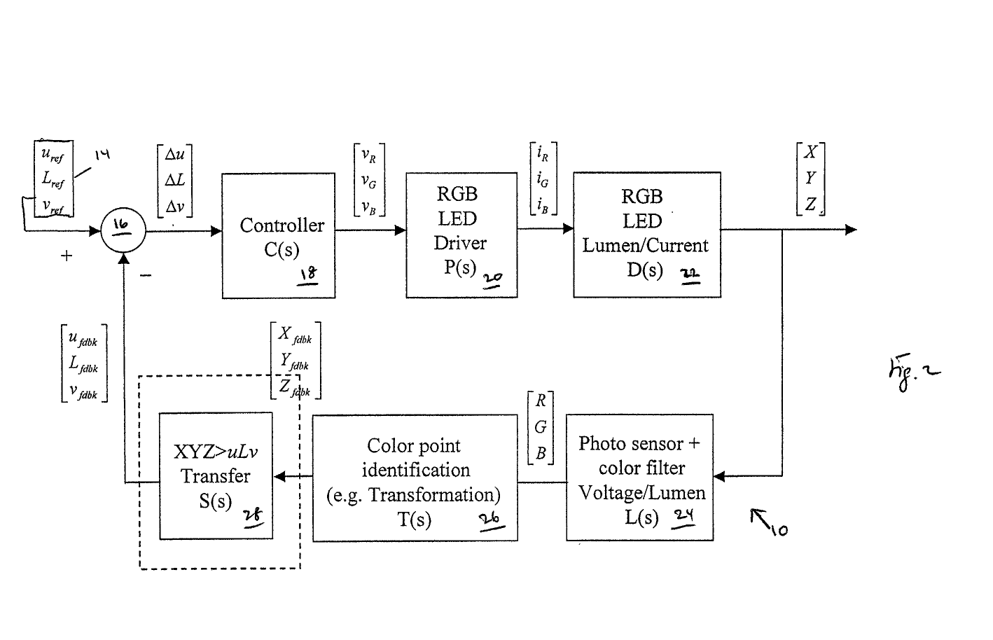

FIG. 2 illustrates a control system 10 for controlling light generated by an RGB, LED luminary module 22 in accordance with one embodiment of the invention. More specifically, in accordance with a preferred embodiment of the invention, control system 10 is employed to control the LEDs to generate a white color light, having reference colorometry coordinate values u_{ref}, L_{-ref} and v_{-ref.}

FIG. 2 includes a buffer 14 that is configured to store the desired colorometry coordinate values of a white light in u, v, L format. It is noted that the uLv space is a nonlinear transformation of XYZ space to create a perceptually linear color space.

Thus, the coordinates stored in buffer 14 correspond to a color space that represents colors relative to a reference white point, which is a specific definition of what is considered white light, represented in terms of XYZ space, and usually based on the whitest light that can be generated by a given device.

The values stored in buffer 14 are referred to as u_{-ref}, L_{-ref}, and V_{31 ref}. Buffer 14 is coupled to a feedback adder 16, which is configured to provide an error signal Δu, ΔL, Δv, based on the desired color coordinate values and the color coordinate values generated by control system 10.

An output port of feedback adder 16 is coupled to a controller 18, which is configured to provide control voltage signals corresponding to the color space error signals. In accordance with one embodiment of the invention, controller 18 is configured to generate control voltage sources V_{R}, V_{G}, V_{B}, for driving the LEDs, in response to error signals provided by feedback adder 16.

An output port of controller 18 is coupled to an input control of power supply and RGB Driver unit 20. Power supply unit 20 generates appropriate forward current signal levels I_{R}, I_{G}, I_{B}, to each of the RGB LEDs so as to cause the LEDs to generate the corresponding lights for producing a desired white light.

An output port of power supply unit 20 is coupled to an input port of an RGB white LED luminary module 22. A plurality of red, green and blue LEDs within luminary module 22 are configured to receive their corresponding forward drive current signals so as to generate the desired white light. Luminary module 22 provides red, green and blue lights in lumen in response to the current provided to the LEDs.

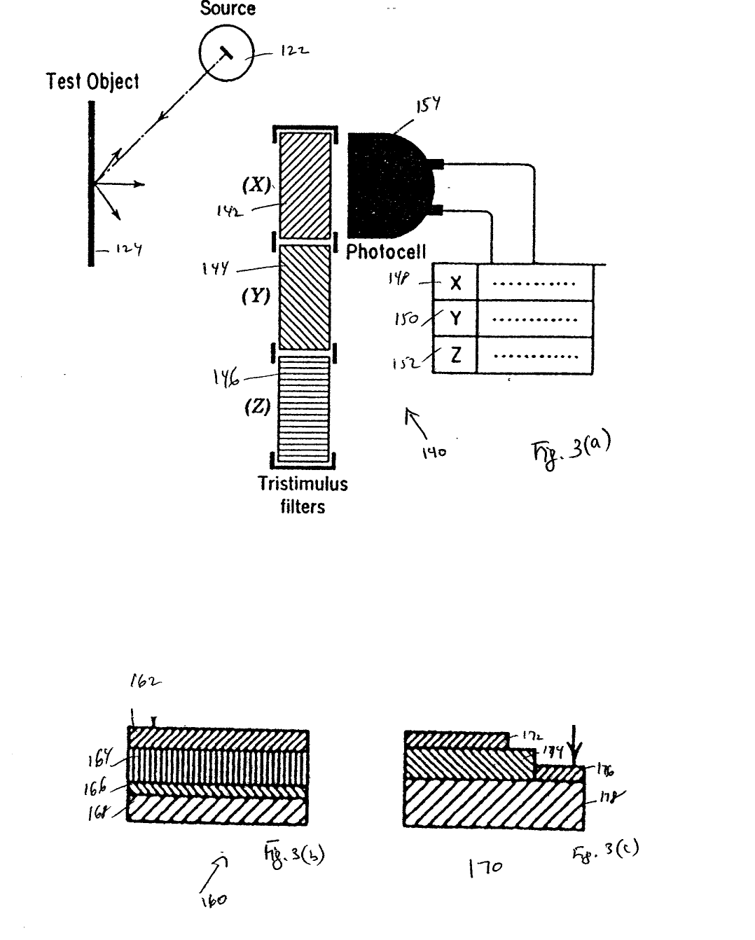

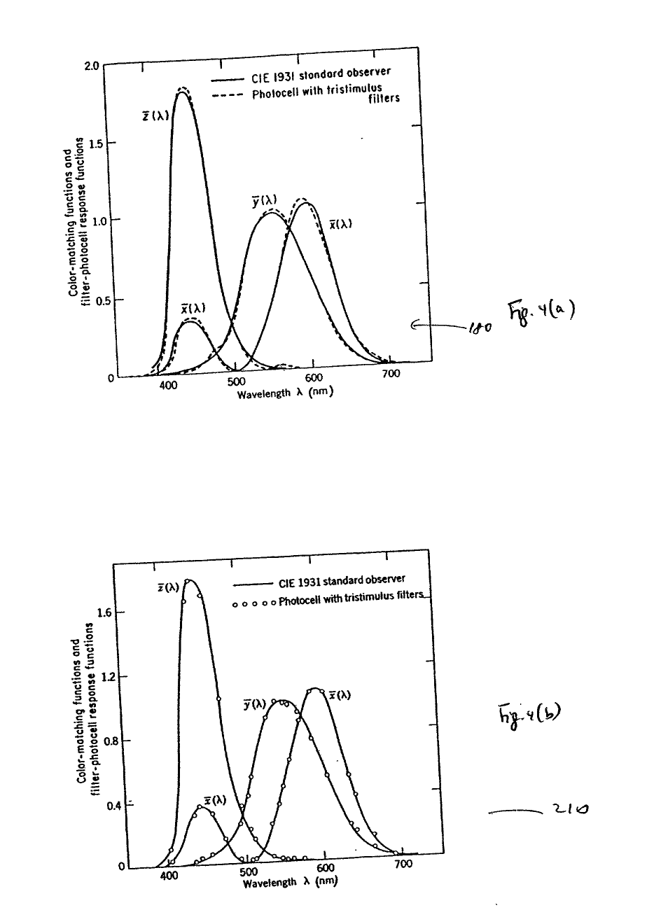

The white light that is generated by luminary 22 is measured by a tristimulus filter 24. Filter 24 is disposed in front of luminary 22 so as to measure certain characteristics of the white light generated, such as the color coordinates RGB. As will be explained in more detail later in reference with FIGS. 3 and 4, filter 24 in accordance with one embodiment of the invention comprises a photo sensor with color filters that together operate as—what is known in the industry—a tristimulus filter.

Filter 24 is coupled to a color point identification module 26, which is configured to convert the RGB values measured by filter 24 to X_{W}, Y_{W}, Z_{w} coordinates.

In accordance with one embodiment of the invention, the operation of filter 24 and color point identification module 26 can be combined by a tristimulus filter, such as 140, illustrated in FIGS. 3(a)-3(c).

The operation and structure of tristimulus filter 140 is well known. FIGS. 3(a), 3(b) and 3(c) illustrate block diagrams of three exemplary tristimulus filters that are employed in accordance with various embodiments of the invention. Basically, a tristimulus filter is configured such that the spectral response functions of the filters are directly proportional to the color-matching functions of CIE standard colorometric observers.

FIG. 3(a) illustrates the arrangement and function of a tristimulus filter 140. The tristimulus filter of FIG. 3(a) includes three glass filters 142, 144 and 146, each of which are configured to filter respectively the red, green and blue lights contained in a light generated by source 122 and reflected by a test object 124. One or more photocells 154 are disposed behind the glass filters to measure the light output for each of the red, green and blue light components. Registers 148, 150 and 152 are configured to store the light information corresponding to CIE 1931 standard observer. Thus, register 148 stores information corresponding to the light passing through filter 142. Similarly, register 150 stores information corresponding to the light passing through filter 144. And, register 152 stores information corresponding to the light passing through filter 146.

To this end, FIG. 4(a) illustrates a plot which depicts the spectral response functions and the degree to which a photocell, such as 154, combined with tristimulus filters 140 may best duplicate the color-matching functions of the CIE 1931 standard observer. The solid curves illustrate the CIE standard observer data, and the dotted curves illustrate response of the photocell with tristimulus filter arrangement.

Other examples of tristimulus filters are illustrated in FIGS. 3(b) and 3(c) wherein filter glass layers are disposed over a filter substrate. Therefore, as illustrated in FIG. 3(b) a substrate 168 receives a glass layer 166, overlapped by a glass layer 164, which in turn is overlapped with a glass layer 162. FIG. 3(c) illustrates another variation of glass layers wherein layer 172 does not completely cover layer 174, and layer 174 does not completely cover layer 176.

To this end, FIG. 4(b) illustrates a plot which depicts the spectral response functions and the degree to which a photocell, such as 154, combined with the tristimulus filters 160 or 170, may best duplicate the color-matching functions of the CIE 1931 standard observer. The solid curves illustrate the CIE standard observer data, and the dotted curves illustrate response of the photocell with tristimulus filter arrangement.

The output port of color identification module 26 is coupled to an input port of a transformation module 28, which is configured to transform the X_{W}, Y_{W}, Z_{W} coordinates of white light measured by module 26 to a uLv space governed by the following equations, for each of the colors red, blue and green:

L=683Y

u=4X/(X+15Y+3Z)

v=6Y/(X+15Y+3Z)

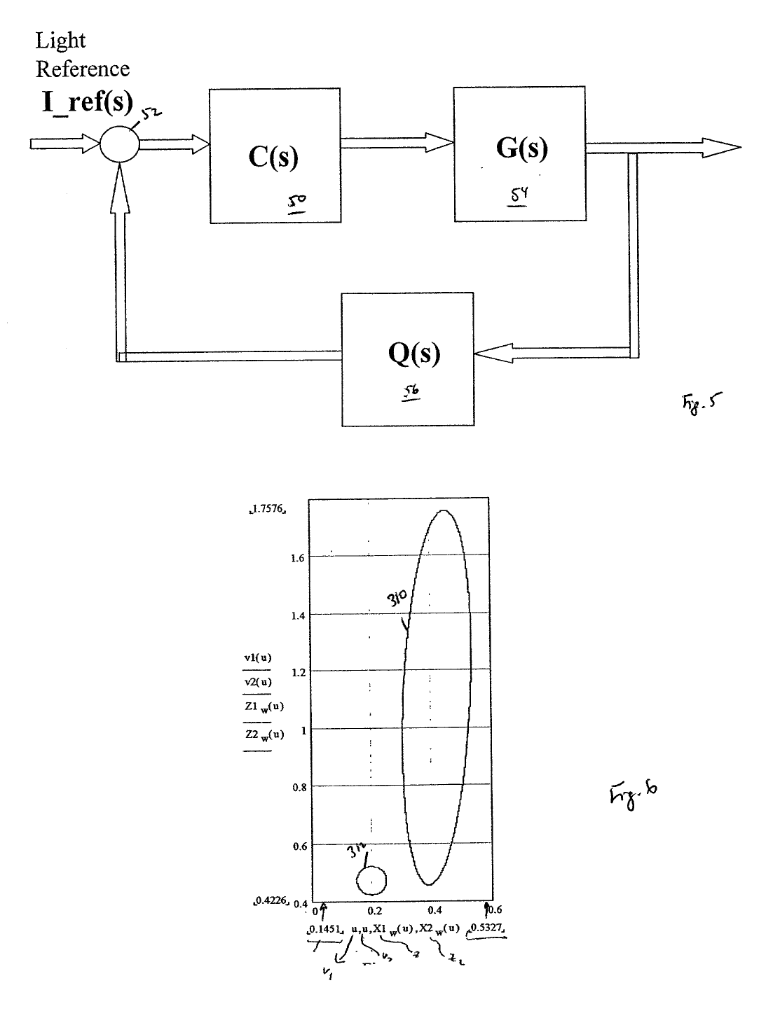

It is noted that the operation and function of color control system 10 can be viewed in accordance with principles of system control theory. FIG. 5 illustrates a block diagram of a unified linearized color control system with RGB LEDs in accordance with one embodiment of the invention. To this end, control module 50 is configured to generate a control signal in accordance with a function C(s) in frequency domain, based on the error signal received from adder 52.

Control module 50 is coupled to a plnt module 54, which in accordance with one embodiment of the invention is configured to provide a signal in accordance with a function G(s) in frequency domain, based on the operation of the driver circuitry and the corresponding Red, Green and Blue LEDs within the plant module A plant module in a control system environment is driven by the control signal generated by the controller.

A feedback module 56, is coupled to the plant module and provides the measured white light color coordinate in accordance with a function Q(s) in frequency domain, to adder 52. Adder 52 also receives the desired white color coordinates as a reference value.

In accordance with one embodiment of the invention, the functions G(s) and Q(s) are defined as

G(s)=D(s)P(s)

Q(s)=S(s)T(s)L(s) and

$${I}_{ref} ( s ) = [ \begin{matrix}{u}_{ref} \\ {L}_{ref} \\ {v}_{ref}\end{matrix} ]$$

wherein D(s) is a transfer function matrix defining the operation of lumninary module 22, P(s) is a transfer function matrix defining the operation of driver module 20, S(s) is a tranfer function matrix defining the operation of transformation module 28 , T(s) is a transfer function matrix defining the operation of transformation module 26, and L(s)is a transfer function matrix defining the operation of filter module 24.

It is noted that a general stability criteria for the color control system in accordance with one embodiment of the invention is that the system will remain stable if and only if

det(I−G(s)C(s)Q(s)) has no zeroes in the closed right half-plane of a complex plane s defined by s=α+jβ wherein α and β are real numbers and j=\overline{−1}, and

[I−G(s)C(s)Q(s)]ˆ (−1)G(s)C(s) is analytic at every closed right half-plane pole of G(s)C(s), over the plane s.

In accordance with another embodiment of the invention the function of the controller as defined by transfer function C(s), can be based on various controller arrangements as is well known in the art. For example, controller 20 can be based on the operation of a class of controllers known as proportional integration (PI) controllers , with a transfer function matrix as

C(s)=Kₚ+K_{I}/s,

wherein Kₚ and K_{I} are 3×3 constant real matrices. Furthermore, in accordance with one embodiment of the invention, the controller is designed so that it dominates the system bandwidth, such that the bandwidth of the controller is smaller than the bandwidth of the driver portion of the RGB LEDs. In other words, the controller portion in this control system has a slower response time than the plant portion of the control system.

Under this condition, as mentioned above, the driver module and the luminary module are effectively configured such that the transfer function G(s) , at sufficiently low frequencies, is defined as

G=D(0)P(0),

wherein D(0) is the DC gain of the luminary module (FIG. 2) defined as lumens/amps, and P(0) is the DC gain of the driver module (FIG. 2) defined as amps/volts.

Furthermore, the filter module, the color point identification module and the transformation module are configured such that the transfer function Q(s), at sufficiently low frequencies is defined as

Q=S(0)T(0)L(0),

wherein L(0) is the DC gain of the filter module (FIG. 2) defined as volts/lumen, and T(0) is the DC gain of color point identification module (FIG. 2) defined as a constant matrix, and S(0) is the DC gain of the transformation module (FIG. 2) also defined as a constant matrix.

In accordance with this embodiment of the invention, the color control system is stable, if and only if

Re{(eig((I−GKₚQ)⁻¹GK₁Q)}<0,

wherein Re{eig . . . } stands for the real part of the eigen value of the matrix, and I is the 3×3 identity matrix.

Thus, in accordance with the embodiment described above, the dynamic gain of the plant need not be considered when configuring the control system for stability. It is noted that the DC gain of the plant can be easily measured, and coefficients Kₚ and K_{I}, can be determined in accordance with the stability requirement of the eigen value described above.

In accordance with one embodiment of the present invention, typical values of the transfer function C(s) for controller 50, for a given RGB LED set, with peak wavelength λᵣ=643 nm λ_{g}=523 nm λ_{b}=464 nm and a selected set of color sensing filters, such as those provided by Hamamatsu™, S6430®, S6429(G) and S6428(B), is

$${K}_{p} = [ \begin{matrix}0.4 & 0.1 & 0.12 \\ 0.17 & 0.6 & 0.1 \\ - 0.14 & 0.03 & 0.7\end{matrix} ] {K}_{I} = [ \begin{matrix}0.8 & 0.12 & 0.18 \\ 0.1 & 0.5 & 0.5 \\ - 0.1 & 0.01 & 0.3\end{matrix} ]$$

It is appreciated by those skilled in the art that the design of the controller system in accordance with the present invention is simplified significantly by measuring the DC gains, instead of considering the dynamic gain of the corresponding modules, when designing the various modules of the control system.

During operation, control system 10, measures the X,Y,Z coordinates of the desired white light generated by luminary module 22 by filter 24, and transforms to a L,u,v color space by transformation module 28. As such, control system 10 controls the color points of the desired while light in the u,v color space with error measured as

Δuv=\sqrt{(u−u₀)²+(v−v₀)²}=ε

wherein (u₀, v₀) is the targeted or desired color point coordinate, and (u,v) is the actual color point coordinate in the u,v color space. As a result control system 10 is able to control white color errors in an arrangement wherein regardless of the location of error on the chromaticity diagram, the perception of color remains the same for the same amount of error. This means that the control system produces substantially a uniform error in color. Therefore, as Δuv becomes smaller, the color difference becomes smaller in all directions as well.

FIG. 6 is a plot illustrating the effect of transformation module 24 has on the XZ and uvcolor spaces, when Y is kept constant. Plot 310 depicts the error control area in XZ required for a system that does not employ transformation module 28. As illustrated, in order to perceive the same white color, control system 10 has to provide a control scheme wherein the XZ error values remain in an area that define an ellipse 310 around the desired white color value. However, a control scheme to provide such an elliptic control area is not without considerable technical challenges.

In contrast, the effect of the transformation module is that the control system provides a control scheme wherein the Δuv values are almost uniform in all directions in an area that defines a circle 312 in uv . As illustrated, plot 310 is defined in XZ coordinates and plot 312 is defined in uv coordinates. As a result, control system 10 can be assembled in an expeditious and a less costly manner.

Thus, in accordance with various aspects of the present invention, a control system can be designed, for an arrangement wherein the controller portion of the control system has a dominant bandwidth compared to the plant portion of the control system. As such, DC gain levels of the plan system can be measured, which significantly simplifies design considerations. Furthermore, for an RGB LED system, a white light can be generated such that deviations from the desired white light remain unperceivable regardless of the direction of error on the chromaticity plot.

I claim:

1. A color control system for generating a desired white light by a plurality of Red, Green and Blue light emitting diodes (LEDs) comprising:
a sensor responsive to a white light generated by said plurality of LEDs to measure the color coordinates of said white light, wherein said color coordinates are defined in a first color space;
a transformation module coupled to said sensor to transform said coordinates of said generated white light to a second color space;
a reference module configured to provide reference color coordinates corresponding to said desired white light, wherein said reference color coordinates are expressed in said second color space;
an adder coupled to said transformation module and said reference module configured to generate an error color coordinate corresponding to a difference between said desired white light color coordinates and said generated white light color coordinates; and
a driver module coupled to said adder and configured to generate a drive signal for driving said LEDs.

2. The system in accordance with claim 1 wherein said first color space is an X,Y.Z color space.

3. The system in accordance with claim 2, wherein said second color space is a uLv color space.

4. The system in accordance with claim 1 further comprising a controller coupled to said adder, wherein said controller generates control voltage signals corresponding to said Red, Green and Blue LEDs respectively.

5. The system in accordance with claim 3 wherein said sensor is a tristimulus filter.

6. The system in accordance with claim 5 wherein said transformation module transforms said X,Y,Z color coordinates such that
L=683Y
u=4X/(X+15Y+3Z)
v=6Y/(X+15Y+3Z)

7. A feedback control system for controlling a plant operation comprising:
a controller portion for providing a control signal in response to an error signal, said controller portion having a first response bandwidth and a transfer function C(s) defined as C(s)=Kₚ+K_{I}/s, wherein Kₚ and K_{I}, are constant real matrices;
a plant portion for receiving said control signal and generating an output signal, said plant portion having a second response bandwidth, and a DC gain matrix defined as G, wherein said first response bandwidth is smaller than said second response bandwidth;
a feedback portion for measuring said desired output signal having a DC gain matrix defined as Q; and
an adder coupled to said feedback portion configured to measure said error signal based on said measured output signal and a desired input signal such that
Re{(eig((I−GKₚQ)⁻¹GK_{I}Q)}<0,
wherein Re {eig . . . } stands for the real part of the eigen value of the matrix, and I is the identity matrix.

8. The system in accordance with claim 7, wherein said plant portion comprises an RGB LED driver module coupled to an RGB luminary module.

9. The system in accordance with claim 8, wherein said feedback portion comprises a sensor coupled to said luminary module;
a color point identification module for transforming values received form said filter to a first color space value system; and
a transformation module for transforming signals received by said identification module to a second color space value system.

10. The system in accordance with claim 9 wherein said first color space is an X,Y.Z color space.

11. The system in accordance with claim 10, wherein said second color space is a uLv current space.

12. The system in accordance with claim 9, wherein said controller portion generates control voltage signals corresponding to said Red, Green and Blue LEDs respectively.

13. The system in accordance with claim 12 wherein said sensor is a tristimulus filter.

14. The system in accordance with claim 13 wherein said transformation module transforms said X,Y,Z color coordinates such that
L=683Y
u=4X/(X+15Y+3Z)
v=6Y/(X+15Y+3Z).

15. A method in a control system for generating a desired white light by a plurality of Red, Green and Blue light emitting diodes (LEDs) comprising the steps of:
sensing a white light generated by said plurality of LEDs to measure the color coordinates of said white light, wherein said color coordinates are defined in a first color space;
transforming said coordinates of said generated white light to a second color space;
providing reference color coordinates corresponding to said desired white light, wherein said reference color coordinates are expressed in said second color space;
generating an error color coordinate corresponding to a difference between said desired white light color coordinates and said generated white light color coordinates; and
generating a drive signal for driving said LEDs.

16. The method in accordance with claim 15 further comprising the step of defining said first color space as an X,Y.Z color space.

17. The method in accordance with claim 15, further comprising the step of defining said second color space as a uLv current space.

18. The method in accordance with claim 15 further comprising the step of generating control voltage signals corresponding to said Red, Green and Blue LEDs respectively.

19. The method in accordance with claim 18 wherein said step of transforming said X,Y,Z color coordinates further comprises the step of assigning values in accordance with
L=683Y
u=4X/(X+15Y+3Z)
v=6Y/(X+15Y+3Z)
